(19) United States
(12) Patent Application Publication
(10) Pub. No.: US 2016/0145448 A1
(43) Pub. Date: May 26, 2016

(54) HIGH SOLIDS COATING COMPOSITION COMPRISING AN ALKYD RESIN AND ISOAMYL ACETATE

(71) Applicant: AKZO NOBEL COATINGS INTERNATIONAL B.V., Arnhem (NL)

(72) Inventors: Martinus Adrianus Anthonius Maria KOENRAADT, Noordwijk (NL); Antonius Hendrikus Gerardus VAN ENGELEN, Noordwijkerhout (NL); Swarup DAS, Karnataka (IN); Justine Martine Ghislaine VANACKÈRE, Leiden (NL); Sundar RAMARATHINAM, Karnataka (IN)

(21) Appl. No.: 14/906,124

(22) PCT Filed: Jul. 23, 2014
(86) PCT No.: PCT/EP2014/065771

§ 371 Date: Jan. 19, 2016

(30) Foreign Application Priority Data
Jul. 26, 2013 (IN) 2231/DEL/2013
Sep. 11, 2013 (EP) 13183933.4

(51) Int. Cl. C09D 7/00; C09D 167/08

(52) U.S. Cl. CPC C09D 7/001; C09D 167/08

(57) ABSTRACT

The invention relates to a non-aqueous liquid coating composition comprising an alkyd resin and a volatile organic solvent, wherein at least 15% by weight of the organic solvent is isoamyl acetate.

The invention relates to a non-aqueous liquid coating composition comprising an alkyd resin and a volatile organic solvent. The invention further relates to a process of coating a substrate, and to a coated substrate.

Volatile organic solvents are required in non-aqueous liquid coating compositions to achieve the necessary viscosity to allow application of the coating composition to a substrate, for example by brushing or spraying. Typical organic solvents in alkyd resin-based coating compositions are aromatic solvents and aliphatic hydrocarbon-based solvents. However, such volatile organic solvents evaporating into the atmosphere contribute to air pollution, photochemical smog, they are generally unhealthy or toxic when the fumes are inhaled by paint applicators, they are usually flammable and pose a fire risk, and they are generally based on mineral oil, which is a valuable non-renewable resource.

Hence, there is a long-felt need to reduce the amount of volatile organic solvents in liquid coating compositions in order to ameliorate the above-mentioned problems. Accordingly, the invention seeks to provide coating compositions which require a lower amount of volatile organic solvents. Furthermore, the volatile organic solvents should at least be partially based on renewable resources.

The invention now provides a non-aqueous liquid coating composition comprising an alkyd resin and a volatile organic solvent, wherein at least 15% by weight of the organic solvent is isoamyl acetate.

It has been surprisingly found that isoamyl acetate has very good diluting power and viscosity reducing properties in combination with alkyd resins. More in particular, the viscosity of alkyd resins dissolved in isoamyl acetate is significantly lower than the viscosity of the same alkyd resins in standard solvents, such as aromatic or aliphatic hydrocarbons. As a consequence, in order to achieve a predetermined target viscosity of an alkyd resin-based coating composition, a reduced amount of organic solvent is required when isoamyl acetate is used.

Furthermore, isoamyl alcohol, the key raw material for isoamyl acetate, is a side product of the production of ethanol by fermentation of carbohydrates. Fermentation of plant-based renewable carbohydrates for the production of ethanol is carried out on a large industrial scale, and the side product from this process, isoamyl alcohol, is available in large quantities.

Alkyd resins are synthetic polyester resins which are esterification products of polyalcohols and polycarboxylic acids, and which contain natural and/or synthetic fatty acids or oils, wherein oils are generally defined as fatty acid triglycerides. Depending on the fatty acid or oil content, alkyds can be classified as short-oil, medium-oil or long-oil resins. Alkyd resins are additionally divided into drying and non-drying resins. These properties depend predominantly on the types and amounts of fatty acids present in the alkyd resin. The presence of unsaturated or multiple unsaturated fatty acids gives rise to drying alkyd resins, which form a crosslinked network when exposed to oxygen. Alkyd resins may also be modified with isocyanates, epoxides, or phenolic compounds, in order to improve specific properties, such as adhesion to metal substrates or pigment wetting.

In a preferred embodiment, the alkyd resin is partly based on recycled polyester. Polyester-based waste material, for example from drink bottles, is collected in many communities and can be used as a raw material in esterification processes to reduce the requirement for fresh mineral oil-based raw materials. Polyethylene terephthalate (PET) is one of the most widely used polyesters suitable for recycling.

Generally, at least 20% by weight of the film-forming material of the coating composition consists of one or more alkyd resins. In preferred embodiments, at least 30% by weight, or even at least 50% by weight of the film-forming material consists of alkyd resin. It is to be understood that the film-forming material includes the non-volatile components of the coating composition, excluding particulate pigments and fillers.

As mentioned above, the coating composition of the invention comprises a volatile organic solvent, and at least 15% by weight of that solvent is isoamyl acetate. A volatile organic solvent is understood to have an initial boiling point of less than or equal to 250° C. measured at a standard atmospheric pressure of 101.3 kPa.

Isoamyl acetate may be blended with other solvents. Good results can be obtained when the volatile organic solvent comprises at least 15% by weight of isoamyl acetate.

The beneficial effect of the dilution behaviour is more pronounced when the volatile organic solvent comprises a higher proportion of isoamyl acetate.

In preferred embodiments, at least 30%, or at least 45% of the volatile organic solvent is isoamyl acetate. It is most preferred that at least 60% of the volatile organic solvent is isoamyl acetate.

As mentioned above, the invention seeks to provide a coating composition having a reduced amount of volatile organic solvents. Accordingly, is it preferred that the volatile organic content of the coating composition of the invention does not exceed 600 g/l. In more preferred embodiments, the volatile organic content does not exceed 500 g/l, or it does not exceed 420 g/l. Generally, the volatile organic content is kept as low as possible at the desired application viscosity.

In addition to the aforementioned content of isoamyl acetate, further volatile organic diluents may be present in the coating composition. Examples of suitable volatile organic diluents are hydrocarbons, such as toluene, xylene, Solvesso 100, ketones, terpenes, such as dipentene or pine oil, halogenated hydrocarbons, such as dichloromethane, ethers, such as ethylene glycol dimethyl ether, esters, such as ethyl acetate, ethyl propionate, n-butyl acetate or ether esters, such as methoxypropyl acetate or ethoxyethyl propionate. Also mixtures of these compounds can be used.

In order to lower the proportion of volatile organic solvent required to achieve the desired application viscosity, non-volatile liquid diluents can be included in the coating composition. Examples of such non-volatile liquid diluents are vegetable oils, such as castor oil or linseed oil, and epoxidized vegetable oils.

If so desired, it is possible to include one or more so-called “exempt solvents” in the coating composition. An exempt solvent is a volatile organic compound that does not participate in an atmospheric photochemical reaction to form smog. It can be an organic solvent, but it takes so long to react with nitrogen oxides in the presence of sunlight that the Environmental Protection Agency of the United States of America considers its reactivity to be negligible. Examples of exempt solvents that are approved for use in paints and coatings include acetone, methyl acetate, parachlorobenzotrifluoride (commercially available under the name Oxsol 100), and volatile methyl siloxanes. Also tertiary butyl acetate is considered to be an exempt solvent.

In one embodiment, the coating composition is provided as a storage stable one-component composition ready for application. Such a composition may comprise a drying alkyd resin, which cures and crosslinks after application under the influence of atmospheric oxygen, or it may be a physically drying coating composition which dries by evaporation of solvent. Alternatively, a storage-stable coating composition may comprise a crosslinking agent which is activated by application of heat or actinic radiation after application of the coating composition.

In a further embodiment, the coating composition is provided as a kit of separately stored parts comprising a binder module comprising an alkyd and a crosslinker module, which modules are mixed prior to application of the coating composition.

Such an embodiment is particularly useful when the coating composition obtained by mixing the binder module and the crosslinker module is not storage stable, for example in cases wherein the crosslinker reacts with crosslinkable groups of components of the binder module at room temperature.

In a preferred embodiment, the binder module comprises a hydroxyl-functional alkyd resin, and the crosslinker module comprises a hydroxyl-reactive crosslinker.

Examples of hydroxyl-reactive crosslinkers are etherified amino resins, guanidine resins, blocked polyisocyanates, and polyisocyanates.

In a preferred embodiment, the crosslinker module comprises a polyisocyanate crosslinker. Suitable isocyanate-functional crosslinkers for use in the crosslinker module are isocyanate-functional compounds comprising at least two isocyanate groups. Preferably, the isocyanate-functional crosslinker is a polyisocyanate, such as an aliphatic, cycloaliphatic or aromatic di-, tri- or tetra-isocyanate. Examples of diisocyanates include 1,2-propylene diisocyanate, trimethylene diisocyanate, tetramethylene diisocyanate, 2,3-butylene diisocyanate, hexamethylene diisocyanate, octamethylene diisocyanate, 2,2,4-trimethyl hexamethylene diisocyanate, dodecamethylene diisocyanate, ω,ω′-dipropylether diisocyanate, 1,3-cyclopentane diisocyanate, 1,2-cyclohexane diisocyanate, 1,4-cyclohexane diisocyanate, isophorone diisocyanate, 4-methyl-1,3-diisocyanatocyclohexane, trans-vinylidene diisocyanate, dicyclohexyl methane-4,4′-diisocyanate (Desmodur® W), toluene diisocyanate, 1,3-bis(isocyanatomethyl) benzene, xylylene diisocyanate, α,α,α′,α′-tetramethyl xylylene diisocyanate (TMXDI®), 1,5-dimethyl-2,4-bis(2-isocyanatoethyl) benzene, 1,3,5-triethyl-2,4-bis(isocyanatomethyl) benzene, 4,4′-diisocyanato-diphenyl, 3,3′-dichloro-4,4′-diisocyanato-diphenyl, 3,3′-diphenyl-4,4′-diisocyanato-diphenyl, 3,3′-dimethoxy-4,4′-diisocyanato-diphenyl, 4,4′-diisocyanato-diphenylmethane, 3,3′-dimethyl-4,4′-diisocyanato-diphenylmethane, and diisocyanatonaphthalene. Examples of triisocyanates include 1,3,5-triisocyanatobenzene, 2,4,6-triisocyanatotoluene, 1,8-diisocyanato-4-(isocyanatomethyl) octane, and lysine triisocyanate. Adducts and oligomers of polyisocyanates, for instance biurets, isocyanurates, allophanates, uretdiones, urethanes, and mixtures thereof are also included. Examples of such oligomers and adducts are the adduct of 2 molecules of a diisocyanate, for example hexamethylene diisocyanate or isophorone diisocyanate, to a diol such as ethylene glycol, the adduct of 3 molecules of hexamethylene diisocyanate to 1 molecule of water (available under the trademark Desmodur N of Bayer), the adduct of 1 molecule of trimethylol propane to 3 molecules of toluene diisocyanate (available under the trademark Desmodur L of Bayer), the adduct of 1 molecule of trimethylol propane to 3 molecules of isophorone diisocyanate, the adduct of 1 molecule of pentaerythritol to 4 molecules of toluene diisocyanate, the adduct of 3 moles of m-α,α,α′,α′-tetramethyl xylene diisocyanate to 1 mole of trimethylol propane, the isocyanurate trimer of 1,6-diisocyanatohexane, the isocyanurate trimer of isophorone diisocyanate, the uretdione dimer of 1,6-diisocyanatohexane, the biuret of 1,6-diisocyanatohexane, the allophanate of 1,6-diisocyanatohexane, and mixtures thereof. Furthermore, (co)polymers of isocyanate-functional monomers such as αaα40 -dimethyl-m-isopropenyl benzyl isocyanate are suitable for use.

In addition to the components described above, other compounds can be present in the coating composition according to the present invention. Such compounds may be main binders and/or reactive diluents, optionally comprising reactive groups which may be crosslinked. Examples include hydroxy-functional binders, e.g. polyester polyols, polyether polyols, polyacrylate polyols, polyurethane polyols, cellulose acetobutyrate, hydroxy-functional epoxy resins, and dendrimeric polyols such as described in International patent application WO 93/17060. Also, hydroxy-functional oligomers and monomers, such as castor oil, trimethylol propane, and diols may be present.

The coating composition can also comprise latent hydroxy-functional compounds such as compounds comprising bicyclic orthoester, spiro-orthoester, or spiro-ortho silicate groups. These compounds and their use are described in WO 97/31073 and WO 2004/031256.

Finally, ketone resins, aspargyl acid esters, and latent or non-latent amino-functional compounds such as oxazolidines, ketimines, aldimines, diimines, secondary amines, and polyamines can be present. These and other compounds are known to the skilled person and are mentioned, in al., in U.S. Pat. No. 5,214,086.

The coating composition may further comprise other ingredients, additives or auxiliaries commonly used in coating compositions, such as pigments, dyes, surfactants, pigment dispersion aids, levelling agents, wetting agents, anti-cratering agents, antifoaming agents, antisagging agents, heat stabilizers, light stabilizers, UV absorbers, antioxidants, and fillers. In embodiments wherein the alkyd resin is an air-drying alkyd, it is preferred to also include drying agents, such as metal salts, and anti-skinning agents in the coating composition.

In a preferred embodiment the two-pack coating composition also comprises a curing catalyst for catalysis of the curing reaction between hydroxy groups and isocyanate groups. Such catalysts are known to the skilled person. The catalyst is generally used in an amount of 0 to 10% by weight, preferably 0.001 to 5% by weight, more preferably in an amount of 0.01 to 1 by weight, calculated on the non-volatile matter of the coating composition. Suitable catalysts include basic catalysts, such as tertiary amines, and metal-based catalysts. Suitable metals include zinc, cobalt, manganese, zirconium, bismuth, and tin. It is preferred that the coating composition comprises a tin-based catalyst. Well-known examples of tin-based catalysts are dimethyl tin dilaurate, dimethyl tin diversatate, dimethyl tin dioleate, dibutyl tin dilaurate, dioctyl tin dilaurate, and tin octoate.

It is also preferred that the two-pack coating composition additionally comprises a pot life extending agent. Pot life extending agents increase the pot life of the coating composition, i.e. the time between mixing of all components and the moment the viscosity becomes too high for the composition to be applied. Pot life extending agents can suitably be present in similar amounts as the curing catalysts mentioned above. Preferred pot life extending agents have only a limited or no negative impact on the drying speed of the coating composition. Thus, these pot life extending agents improve the balance of pot life and drying speed. Examples of suitable pot life extending agents are carboxylic acid group-containing compounds, such as acetic acid, propionic acid or pentanoic acid, and aromatic carboxylic acid group-containing compounds, such as benzoic acid.

Other suitable pot life extending agents are dicarbonyl compounds, such as 2,4-pentanedione, phenolic compounds, and thiol group-containing compounds.

The coating composition can be applied to any substrate. Application can be carried out by any method which is suitable for applying liquid coating compositions, such as brushing, rolling, dipping, or spraying. The substrate may be, for example, metal, e.g., iron, steel, and aluminium, plastic, wood, glass, synthetic material, paper, leather, or another coating layer. The coating compositions show particular utility as clear coats, base coats, pigmented top coats, primers, and fillers. When the coating composition is a clear coat composition, it is preferably applied over a colour- and/or effect-imparting base coat. In that case, the clear coat forms the top layer of a multi-layer lacquer coating such as typically applied on the exterior of automobiles. The base coat may be a water borne base coat or a solvent borne base coat. The coating compositions are suitable for coating objects such as bridges, pipelines, industrial plants or buildings, oil and gas installations, or ships. The compositions are particularly suitable for finishing and refinishing transportation vehicles, such as automobiles, trains, trucks, buses, and airplanes, or parts thereof.

The invention also relates to process of coating a substrate, wherein the coating composition of the invention is applied to the substrate to form a coating layer. As mentioned above, the coating layer may be part of a multilayer coating system, for example a clear or pigmented top coat layer, or a pigmented primer layer. In a specific embodiment, the substrate is a transportation vehicle or a part thereof.

The invention further relates to a substrate which is at least partly covered by a coating layer obtained by the process.

### EXAMPLES

### Raw Materials and Methods

The molecular weights were determined by size exclusion chromatography using polystyrene as standard.

Acid values and hydroxyl values are calculated and indicated based on non-volatile content.

Flow of the coating was visually judged and the Wavescan® by Byk-Garner was used to determine small surface irregularities (Short Wave) and large surface irregularities (Long wave) to give a value for “orange peel”. Both values have to be as low as possible for a smooth surface.

Dust-free time of coatings was determined by light touching and checking if cotton could be blown off the surface,

Free-to-handle time was determined by pressing the coating with a thumb and when the finger print disappeared within 30 seconds, the coating was free to handle.

| | |
|---|---|
| Desmodur L75 | Polyisocyanate ex Bayer |
| ColorBuild Plus ® | Primer ex AkzoNobel |

### Example 1 and Comparative Example A

A long oil (61.3%) soybean oil-based alkyd resin was provided as a 98.2% solution in xylene. In Example 1 the resin was diluted with isoamyl acetate, and in Comparative Example A the resin was diluted with a hydrocarbon-based solvent (Shellsol D40). The viscosity was measured at various solids contents at 23° C., using a Physica MCR 301 rheometer at 200 s⁻¹.

The viscosity data in Pa·s at various solids contents are summarized in Table 1:

| Solids % | Comp. Ex. A | Example 1 |
|---|---|---|
| 98.2 | 937 | 937 |
| 90.0 | 228 | 43.5 |
| 80.0 | 44.2 | 3.3 |
| 70.0 | 4.8 | 0.50 |
| 65.0 | 1.9 | 0.22 |

It can be inferred from Table 1 that the viscosity reduction is much more effective in Example 1, wherein the alkyd resin is diluted with isoamyl acetate, than in Comparative Example A, wherein the alkyd resin is diluted with ShelIsol D40. Hence, a target viscosity can be achieved with a lower amount of solvent when isoamyl acetate is used as solvent.

In Example 2 and Comparative Example B alkyd resins were prepared from the raw materials indicated in Table 2. The amounts of the raw materials are given in parts by weight (pbw). Table 2 also summarizes the resin properties. It is again demonstrated that the use of isoamyl acetate allows for a much better viscosity reduction than the standard solvent xylene.

TABLE 2

| Alkyd Resin | Example 2 | Comp. Ex. B |
|---|---|---|
| Composition (pbw) | | |
| Pentaerythritol | 13.2 | 13.2 |
| Trimethylol propane | 6.6 | 6.6 |
| Glycerol | 3.5 | 3.5 |
| Soybean oil | 30.8 | 30.8 |
| Castor oil | 7.6 | 7.6 |
| Phthalic anhydride | 29.8 | 29.8 |
| Benzoic acid | 8.5 | 8.5 |
| Data: | | |
| Solvent | Isoamyl acetate | Xylene |
| Solid content (%) | 69.8 | 70.8 |
| Viscosity (Pa · s) | 3.1 | 8.5 |
| Av (mg KOH/g) | 3.4 | 3.6 |
| OHv (mg KOH/g) | 116 | 113 |
| Mn | 2656 | 2525 |
| Mw | 20022 | 15250 |

Pigmented top coat compositions were prepared by mixing the components shown in Table 3. The amounts are given in parts by weight (pbw).

The compositions were applied to cold rolled steel panels which were pre-coated with ColorBuild Plus® and sanded, and allowed to cure at 23° C.

TABLE 3

| | | | Comparative | |
|---|---|---|---|---|
| | Example 3 | | Example C | |
| Resin sol. Ex. 2 | 80 | | | |
| Resin sol. Comp. Ex. B | | | 80 | |
| Yellow pigment paste | 10 | | 10 | |
| Blue pigment paste | 10 | | 10 | |
| Tinuvin 292 | 1 | | 1 | |
| Byk 331 | 0.3 | | 0.3 | |
| Isoamyl acetate | 55 | | | |
| Xylene | | | 80 | |
| total | 156.3 | | 181.3 | |
| Desmodur L75 | 35 | | 35 | |
| Solids (%) | 50.3 | | 45.5 | |
| VOC (g/l) | 492 | | 555 | |
| Visc.(Din Cup 4, sec.) | 18.1″ | | 17.7″ | |
| Visc. After 2 h | 19.8″ | | 19.5″ | |
| Dust-free time | 40 | min | 38 | min |
| Free-to-handle-time | 160 | min | 165 | min |
| Dry film thickness | 51 | μm | 50 | μm |

| | | |
|---|---|---|
| Flow | Good | Moderate |
| Wavescan LW | 6.4 | 22.2 |
| Wavescan SW | 14.9 | 25.1 |

It can be inferred from Table 3 that the coating composition according to the invention of Example 3 has a higher solids content and lower VOC at comparable viscosity than the comparative composition of Example C. In addition, the coating composition according to the invention also has fewer surface irregularities at similar drying speed than the comparative composition.

1. A non-aqueous liquid coating composition comprising an alkyd resin and a volatile organic solvent, wherein at least 15% by weight of the organic solvent is isoamyl acetate.

2. The coating composition of claim 1, wherein the volatile organic content of the coating composition does not exceed 600 g/l.

3. The coating composition according to claim 1, wherein the coating composition is provided as a storage stable one-component composition ready for application.

4. The coating composition according to claim 1, wherein the coating composition is provided as a kit of separately stored parts comprising a binder module comprising the alkyd resin and a crosslinker module, wherein the modules are mixed prior to application of the coating composition.

5. The coating composition according to claim 4, wherein the binder module comprises a hydroxyl-functional alkyd resin and wherein the crosslinker module comprises a hydroxyl-reactive crosslinker.

6. The coating composition according to claim 5, wherein the hydroxyl-reactive crosslinker is a polyisocyanate.

7. A process of coating a substrate, the process comprising applying the a coating composition according to claim 1 to the substrate to form a coating layer.

8. The process according to claim 7, wherein the formed coating layer is part of a multilayer coating system.

9. The process according to claim 8, wherein the formed coating layer is a clear or pigmented top coat layer.

10. The process according to claim 8, wherein the formed coating layer is a pigmented primer layer.

11. The process according to claim 7, wherein the substrate is a transportation vehicle or a part thereof.

12. A substrate which is at least partly covered by a coating layer, wherein the coating layer is obtained by the process according to claim 7.

13. The coating composition according to claim 2, wherein the coating composition is provided as a storage stable one-component composition ready for application.

14. The coating composition according to claim 2, wherein the coating composition is provided as a kit of separately stored parts comprising a binder module comprising the alkyd resin and a crosslinker module, wherein the modules are mixed prior to application of the coating composition.

15. The coating composition according to claim 14, wherein the binder module comprises a hydroxyl-functional alkyd resin and wherein the crosslinker module comprises a hydroxyl-reactive crosslinker.

16. The coating composition according to claim 15, wherein the hydroxyl-reactive crosslinker is a polyisocyanate.

17. A process of coating a substrate, the process comprising applying the coating composition according to claim 2 to the substrate to form a coating layer.

18. The process according to claim 17, wherein the formed coating layer is part of a multilayer coating system.

19. The process according to claim 18, wherein the formed coating layer is a clear or pigmented top coat layer.

20. The process according to claim 17, wherein the substrate is a transportation vehicle or a part thereof.
